(19) United States
(12) Patent Application Publication
(10) Pub. No.: US 2002/0072046 A1
(43) Pub. Date: Jun. 13, 2002

(54) Triangular table: chemistry puzzle and teaching device

(76) Inventor: William Possidento, Park Ridge, NJ (US)

Correspondence Address: John P. Halvonik, Ste 301, 806 West Diamond Ave., Gaithersburg, MD, 20878, US

(21) Appl. No.: 09/734,916

(22) Filed: Dec. 13, 2000

(51) Int. Cl. G09B 19/00

(52) U.S. Cl. 434/282

(57) ABSTRACT

A puzzle apparatus for the study of chemistry and its history and based upon the Zmaczynski equilateral triangular model of the periodic table of the chemical elements. A triangular shaped base is used as a puzzle base and it is shaped and sized in order accommodate rhombohedron shaped pieces that fit into the base and form an overall triangular shape when the puzzle is complete. A successfully completed puzzle would have each piece reflecting a chemical element in its correct place in the periodic chart in the Zmaczynski representation.

### FIELD AND BACKGROUND OF THE INVENTION

The invention relates to the field of teaching devices and, in particular, to a puzzle based upon the periodic table of the chemical elements which involves rhombohedron shaped pieces that are fitted into a triangular base having a shape for accommodating these pieces. The triangular shaped base corresponds to a triangular shaped representation of the periodic table of elements that reflects those presentations as developed by Zmaczynski, Booth and Wagner.

In the present invention, the Zmaczynski equilateral triangle representation of the elements is thus represented by the shape of the puzzle board having a triangular shape and series of pieces that correspond to the elements of the periodic table.

The challenge for the student is to use the information on the pieces (e.g. electron configuration) and use that to place those elements (really the pieces) into their correct positions in the puzzle board and, thus, in the correct relationship with the other elements and to so complete the periodic table as represented by Zmaczynski.

### PRIOR ART

While there are puzzles that are known in the prior art, none of them are based upon a triangular framework that represents the periodic display of the chemical elements. Nor are there known any chemistry puzzles that are based upon the Zmaczynski equilateral triangle representation of the periodic table of elements. Nor for that matter, are there any known chemical puzzles based upon completing a puzzle of the periodic chart in a triangular representation.

### SUMMARY OF THE INVENTION

A puzzle apparatus for the study of chemistry and based upon the Zmaczynski equilateral triangular model of the periodic table of the chemical elements. The puzzle is in the form of a triangular shaped base having side walls and an enclosed area that can hold a number of pieces corresponding to the chemical elements of the periodic chart. In this invention, the puzzle takes it shape and the order of the pieces from the Zmaczynski equilateral triangle representation of the periodic chart. Puzzle pieces representing the elements of the periodic table are placed into the triangular shaped base in the manner suggested by this representation.

Each of the puzzle pieces is a rhombohedron and each of the six faces of each piece is identical in size and shape. The only difference among the faces of each piece is that each face displays a different type of information, e.g. atomic weight, electronic configuration, oxidation, states, boiling pt. melting pt. etc. The student will use this information contained on each piece in order to replace the pieces into their correct position in the triangular base according to the placement established of the elements in the Zmaczynski representation.

It is an object of the invention to provide a learning puzzle for allowing students to construct a periodic table displaying the elements in a triangular shape along the lines of the Zmaczynski presentation.

Another object of the invention to provide a learning puzzle to provide students with a triangular shaped version of the periodic table and to challenge them to fill up the empty table with pieces corresponding to the various elements that make up the table.

Another object is to provide a provide a learning puzzle to study the Zmaczynski equilateral representation of the periodic table and to understand the relationships of the elements with one another according to this presentation.

Other advantages will be seen by those skilled in the art once the invention is shown and described.

### DESCRIPTION OF DRAWINGS

FIG. 1 periodic table based upon the Zmaczynski equilateral triangular representation;

FIG. 2 view of one face of the triangular table puzzle showing rhombohedral shaped pieces correctly fitted into the apertures in the puzzle;

FIG. 3 detailed view of honey combed shaped apertures used in the face of the puzzle;

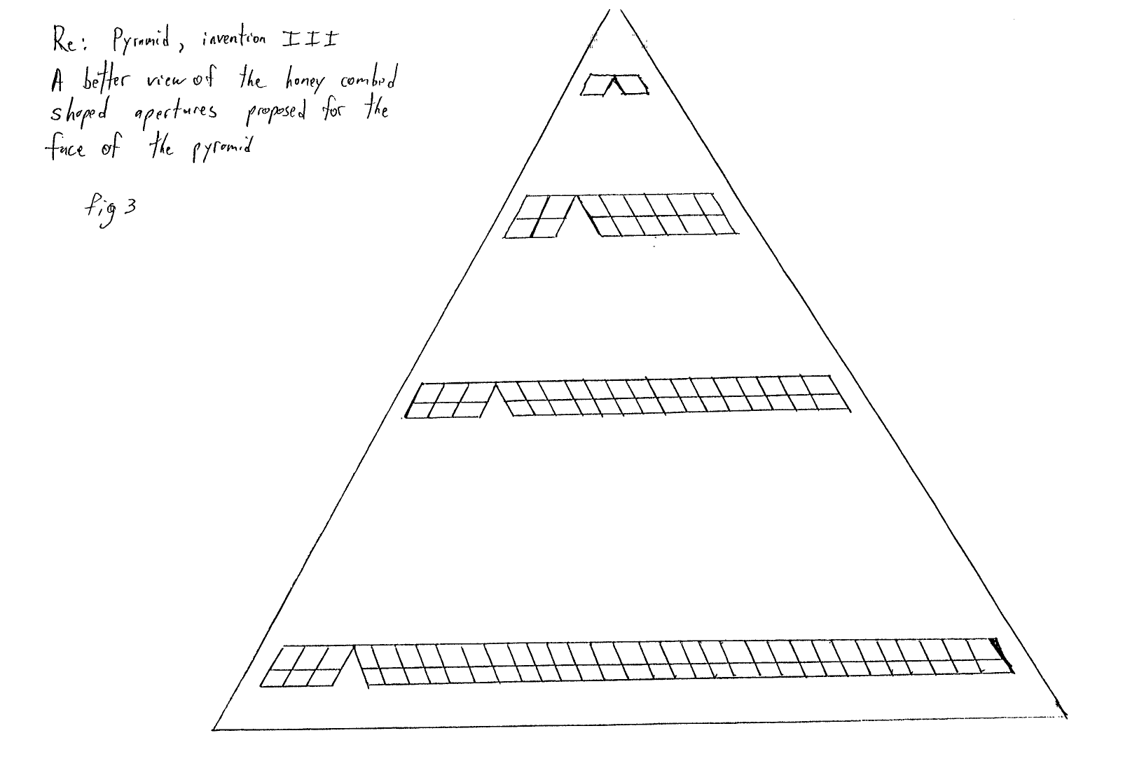

FIG. 4 rhombohedral shaped piece with four equal sides, for use in the puzzle;

FIG. 5 Equilateral piece with size identically shaped faces for use in the puzzle.

### DESCRIPTION OF THE PREFERRED EMBODIMENT

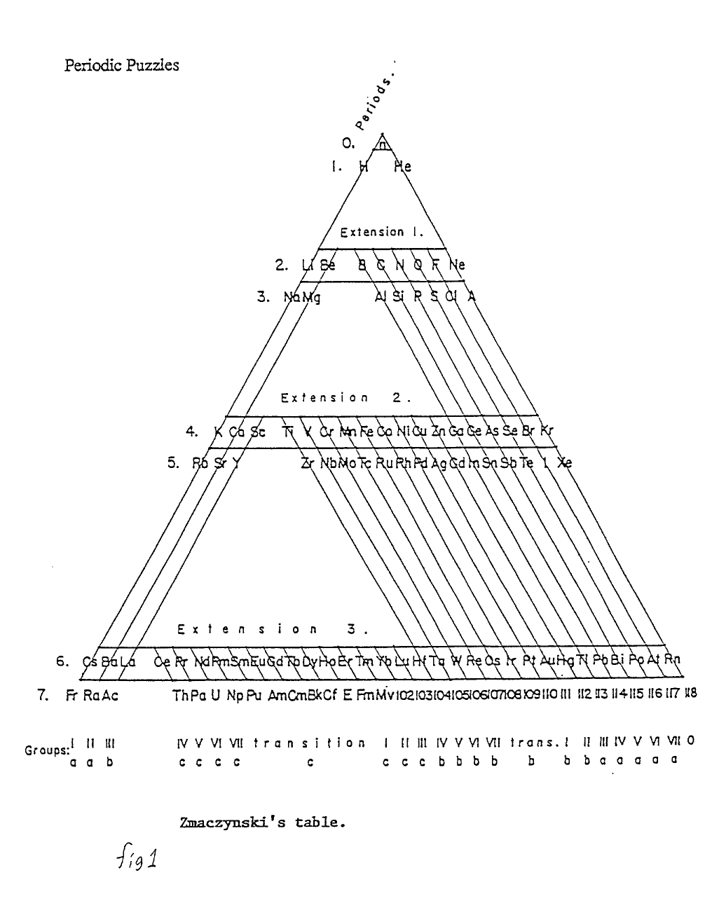

The overall equilateral triangular periodic table that forms the basis for this puzzle is shown in FIG. 1. This triangular representation is attributed to the work of Zmaczynski and also to the work of Wagner and Booth and displays the elements starting with the lightest, Hydrogen and Helium, at the top of the triangle and works its way downward through all the elements. The rows of the triangle correspond to those rows in the standard periodic table.

The dichotomy is not necessarily even in any given row, that is: there are not equal numbers of rightward leaning and leftward leaning rhomboids in the display of any given row (exception: first row of Helium and Hydrogen).

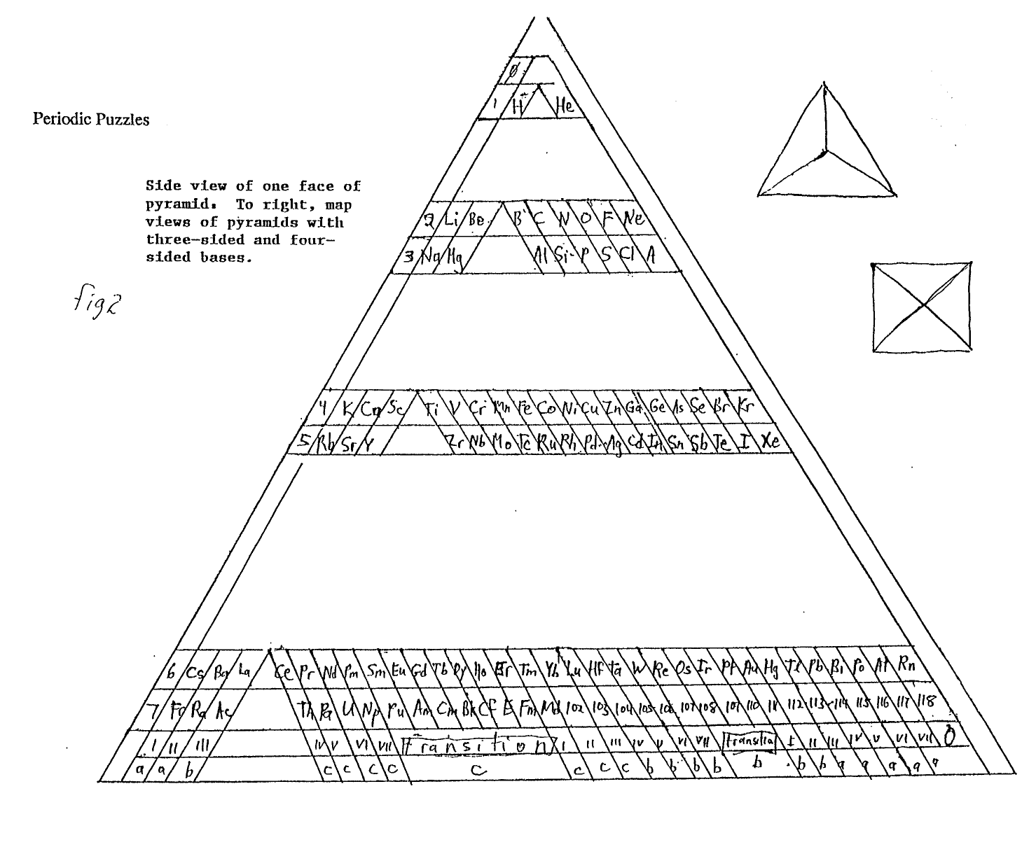

The triangular shaped table, shown in FIG. 2, thus has a series of apertures that correspond to those same rhomboid shaped depictions that are used in the Zmaczynski display to display each of the elements. Thus the apertures in the pyramid base are rhomboid shaped and lean in the direction appropriate for that element that corresponds to that position in the periodic table so as to conform to the equilateral triangular presentation. Thus the shape as well as the placement of each aperture on the face of the pyramidal puzzle corresponds to an element in the Zmaczynski presentation.

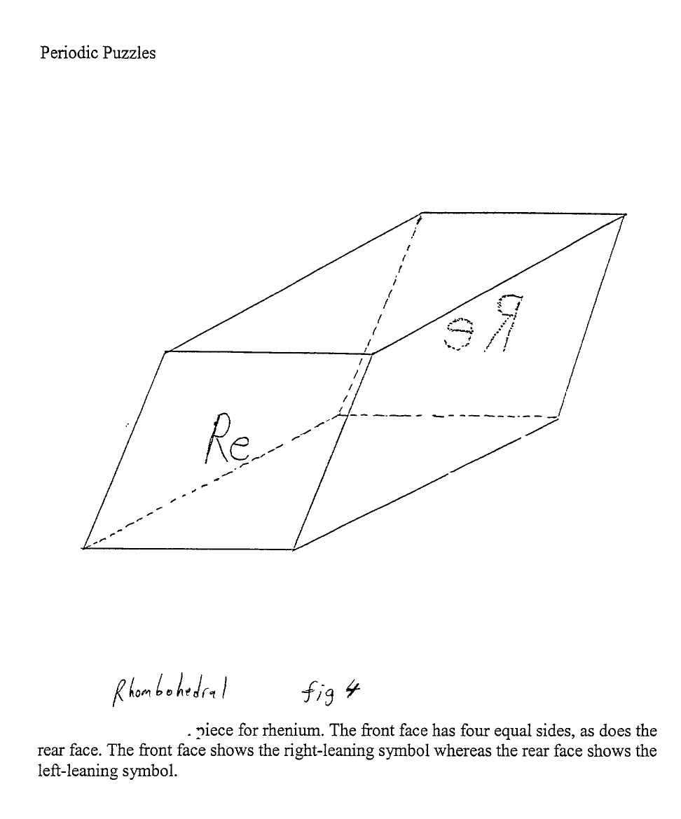

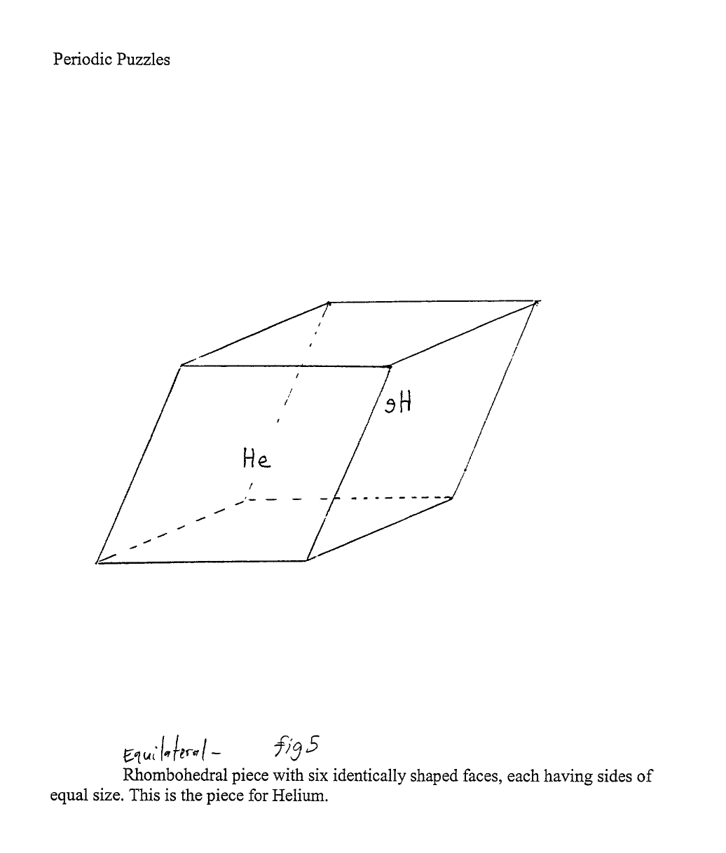

The second part of the invention are the puzzle pieces that are fit into the apertures in the pyramid. Each piece is three dimensional and each piece may be either rhomboid shaped (see FIG. 4) or equilateral shaped (i.e. with equal sizes for all edges, see FIG. 5). Each piece, of course, represents an element from the periodic table. Each of the faces of the piece can be used to display information such as: chemical name, chemical symbol, electronic configuration, oxidation states, and/or boiling point, etc.

Each face could display more than one bit of information, for example, it might be more appropriate to display both the chemical name and the symbol on the same face. In the examples shown in FIGS. 4 and 5 however, only the elemental symbol of the element is depicted there.

In order to keep the student from having too much information on the puzzle piece and using it to solve the puzzle, opposite sides of each piece would have the same information. For instance in the rhomboid shaped piece shown in FIG. 4, the symbol for Rhenium (“Re”) must be on the both the front and the rear of this piece as can be seen. The same is true for the other sides, if say electronic configuration is used on another side, then this identical configuration information must be used on the side opposite that one.

In this way, the information (such as “Re”) will appear on both a leftward leaning and a rightward leaning face of the piece and so prevent the student from discerning where the piece goes by using the lean of the piece to help him solve the puzzle. Thus, with 6 faces each on a the equilateral or rhomboid shaped puzzle piece, there can be at most, three sets of information since each bit of information needs to be duplicated on two sides of the piece.

The challenge for the student is to place the rhomboid or equilateral shaped pieces corresponding to each of the elements of the periodic table into their correct positions on the face of the pyramid. The student would use the chemical information from one side or several sides of the piece.

The puzzle may be comprised of for example: wood plastic or other materials that may be applicable. The rhomboid or equilateral shaped pieces may be made of various materials including wood, plastic, etc.

I claim:

1. A two part teaching puzzle apparatus based upon the Zmaczynski presentation of the periodic table; a first part triangular shaped base including a bottom surface and three side edges in connection with said base, a set of rhombohedral shaped pieces, each of said pieces having six faces, each of said faces of said set having a type of chemical information; said base having size and shape to accommodate said set of pieces in the pattern described by the Zmaczynski presentation.
